(19) United States
(12) Patent Application Publication
(10) Pub. No.: US 2023/0093949 A1
(43) Pub. Date: Mar. 30, 2023

(54) SYSTEM AND METHOD FOR IMPLEMENTING WIN-WIN ONLINE MULTIPLAYER COMPUTER GAME BATTLES

(71) Applicant: VINTERSAGA GAMES LIMITED, Nicosia (CY)

(72) Inventors: OLGA DUNAEVA, Moscow (RU); DAVID YESAYAN, Moscow (RU)

(73) Assignee: VINTERSAGA GAMES LIMITED, Nicosia (CY)

(21) Appl. No.: 17/485,534

(22) Filed: Sep. 27, 2021

(51) Int. Cl. A63F 13/798; A63F 13/58; A63F 13/822; A63F 13/847

(52) U.S. Cl. CPC A63F 13/798; A63F 13/58; A63F 13/822; A63F 13/847

(57) ABSTRACT

In order to obviate one or more of the above and other problems associated with conventional systems and methods for rewarding players in online multiplayer computer games, there are provided systems and methods for implementing win-win game battles in an online multiplayer computer game, wherein the players are rewarded for the battle based on their contributions and not based solely on the fact of winning the battle. In one or more embodiments, the player's contribution can be determined in a variety of different ways, including, for example: damage inflicted on opponents (the most simplified version); the amount of damage done, damage experienced, damage healed; and any other combination of these metrics, or others, depending on the specific implementation of the game mechanics. As a result, in one or more embodiments, all game players are considered victorious in the battle, and those who fight longer and who have done more damage to opponents receive a higher reward.

### BACKGROUND OF THE INVENTION

### Technical Field

The disclosed embodiments relate in general to online multiplayer computer gaming technology and, more specifically, to systems and methods for implementing win-win game battles in an online multiplayer video game.

### Description of the Related Art

In conventional online multiplayer computer game battles, a winning and a losing game player (or several winners and losers) are usually determined at the end of the computer game battle. The conventional form of rewarding online multiplayer computer game players who participated in the online multiplayer computer game battle is awarding one reward for the act of winning the computer game battle. On the other hand, computer game players, who lost online multiplayer computer game battle either do not receive anything or even punished for the act of their loss of the game battle. However, this type of incentive technique may discourage current computer game battle losing players from participating in the computer game battles in the future, or even quitting particular computer game altogether.

Accordingly, conventional online multiplayer computer game technology may discourage current computer game battle losing players from participating in the computer game battles in the future, or even quitting particular computer game altogether and rewarding only computer game battle winners is not always advisable: sometimes it is desirable to have a game or a battle where there are no losers, and all participating players receive a reward, the size of which is determined by their individual contribution to the computer game battle.

### SUMMARY OF THE INVENTION

The embodiments described herein are directed to methods and systems that substantially obviate one or more of the above and other problems associated with conventional systems and methods for rewarding players in online multiplayer computer games.

In accordance with one aspect of the embodiments described herein, there is provided a computer-implemented method performed in a computerized system comprising a central processing unit, a network interface and a memory, the computer-implemented method for implementing win-win game battles in an online multiplayer computer game, wherein the online multiplayer computer game players are rewarded for the game battle based on their personal or team contributions and not based solely on the fact of winning the game battle.

In one or more embodiments, the online multiplayer computer game player's contribution is determined based on player's actions such as damage, healing, curing, building, assisting to other players or in game characters or other actions of the player according to the particular gameplay implementation.

In one or more embodiments, the online multiplayer computer game player's contribution is determined based on an amount of damage done, damage experienced, damage healed during the gameplay.

In one or more embodiments, the online multiplayer computer game player's contribution is determined based on a combination of metrics, based on a specific implementation of the online multiplayer computer game mechanics.

In one or more embodiments, all online multiplayer computer game players are considered victorious in the game battle, and those online multiplayer computer game players who done more specified actions receive a higher reward.

In accordance with another aspect of the embodiments described herein, there is provided a non-transitory computer-readable medium embodying a set of computer-executable instructions, which, when executed in a computerized system comprising a central processing unit, a network interface and a memory, cause the computerized system to perform a method for implementing win-win game battles in an online multiplayer computer game, wherein the online multiplayer computer game players are rewarded for the game battle based on their contributions and not based solely on the fact of winning the game battle.

In one or more embodiments, the online multiplayer computer game player's contribution is determined based on specific actions performed in the game.

In one or more embodiments, the online multiplayer computer game player's contribution is determined based on an amount of damage done, damage experienced, damage healed during the battle.

In one or more embodiments, the online multiplayer computer game player's contribution is determined based on a combination of metrics, based on a specific implementation of the online multiplayer computer game mechanics.

In one or more embodiments, all online multiplayer computer game players are considered victorious in the game battle, and those online multiplayer computer game players who done more specified actions receive a higher reward.

In accordance with yet another aspect of the embodiments described herein, there is provided a computerized system comprising a central processing unit, a network interface and a memory storing a set of instructions executable by the central processing unit, the set of instructions comprising instructions for performing a method for implementing win-win game battles in an online multiplayer computer game, wherein the online multiplayer computer game players are rewarded for the game battle based on their contributions and not based solely on the fact of winning the game battle.

In one or more embodiments, the online multiplayer computer game player's contribution is determined based on damage inflicted on game opponents.

In one or more embodiments, the online multiplayer computer game player's contribution is determined based on an amount of damage done, damage experienced, damage healed during the battle.

In one or more embodiments, the online multiplayer computer game player's contribution is determined based on a combination of metrics, based on a specific implementation of the online multiplayer computer game mechanics.

In one or more embodiments, all online multiplayer computer game players are considered victorious in the game battle, and those online multiplayer computer game players who fight longer and who have done more damage to game opponents receive a higher reward.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of a distributed computerized system for implementing win-win game battles in an online multiplayer computer game.

FIG. 2 illustrates an exemplary embodiment of an operating sequence of a distributed computerized system for implementing win-win game battles in an online multiplayer computer game.

FIG. 3 illustrates an exemplary embodiment of a computer platform for implementing win-win game battles in an online multiplayer computer game.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general-purpose computer, video game console, or other devices that output a video signal or visual image to display a video game that one or more people can play or other forms of a specialized hardware, or combination of software and hardware.

Accordingly, in order to obviate one or more of the above and other problems associated with conventional systems and methods for rewarding players in online multiplayer computer games, there are provided systems and methods for implementing win-win game battles in an online multiplayer computer game, wherein the players are rewarded for the battle based on their contributions and not based solely on the fact of winning the battle.

In one or more embodiments, the online multiplayer computer game player's contribution can be determined in a variety of different ways, including, for example:
Damage, healing, curing, building, assisting to other players or in game characters or other actions of the player according to the particular gameplay implementation;
The amount of damage done, damage experienced, damage healed during the battle;
Any other combination of these metrics, or others, depending on the specific implementation of the online multiplayer computer game mechanics.

As a result, in one or more embodiments, all online multiplayer computer game players are considered victorious in the battle, and those who fight longer and who have done more damage to opponents receive a higher reward.

### Description of the Gaming Computer System

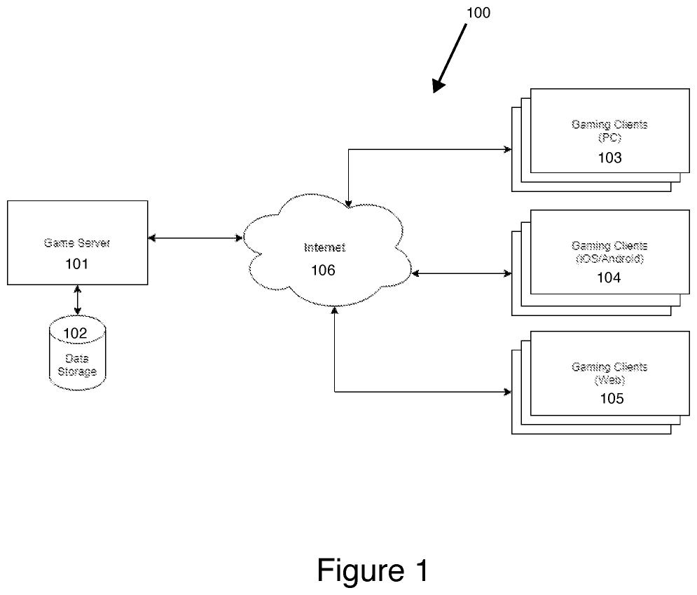

In one or more embodiments, the win-win online computer game battles are implemented on the basis of the classic client-server architecture 100 with a game server 101 working in conjunction with a centralized data storage 102 shown in FIG. 1. Game clients, 103, 104 and 105, communicatively coupled to the game server 101 via Internet or other now known or later developed computer data networks 106, can be implemented using different devices: players from PC 103, mobile platforms 104 and browser with thin or fat clients 105 or any other Network enabled devices, including video game consoles, can participate in the same online game battle.

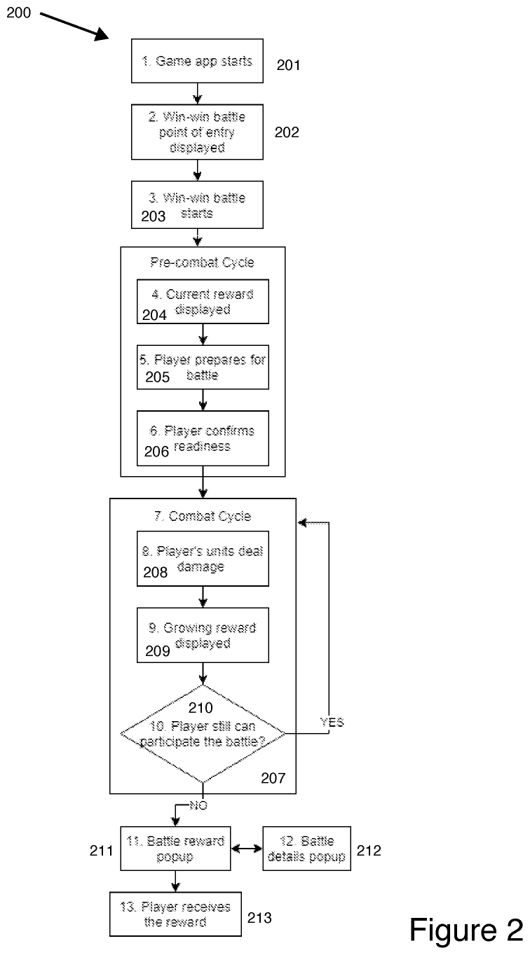

FIG. 2 illustrates an exemplary operating sequence of an embodiment of a method for implementing win-win game battles in an online multiplayer computer game, where the players are rewarded for the battle based on their contributions and not based solely on the fact of winning the battle.

At step 201, the online computer game player launches the game application.

At step 202, the online computer game player sees the entry point to a win-win battle;

At step 203, the player enters a win-win battle (it is possible to charge a fee in game currency);

At step 204, on the battle screen, the online computer game player sees the counter of the expected reward for the battle, which is currently zero;

At step 205, the online computer game player performs the necessary preparatory actions (depending on the specific game mechanics);

At step 206, the online computer game player confirms his readiness for battle (can be skipped);

At step 207, a game battle starts (upon confirmation of readiness by all players, or at a predetermined time);

At step 208, the online computer game player observes the progress of the battle, taking, if possible, direct or indirect participation in it (depending on the specific game mechanics);

At step 209, in the course of the game battle, the online computer game player sees the growing value of his own reward, changes should be displayed instantly or with the minimum possible delay, determined by the technical limitations of the system; the size of the reward is calculated based on the data on the player's contribution at the current moment;

The course of the battle is calculated or verified on the server side, independent of the client application installed on the players' devices. This eliminates the possibility of foul play and unwanted manipulation of one's own contribution;

At step 210, the online computer game player's participation in the battle ends in any way (see the conditions for ending the participation in the battle)

At step 211, the online computer game player sees a window displaying his final reward;

At step 212, the online computer game player can view the details of the award, which is a display of the full set of metrics of his own contribution, and the corresponding parts of the award; and

At step 213, the online computer game player accepts the reward (transferred to his account in game currency, game resources, game values or in another form).

Exemplary conditions for completing participation in the game battle will now be described.

In one or more embodiments, the online computer game player continues to participate in the battle until the condition for the completion of his participation is triggered, there are several options for the conditions:
The character or characters of the player (or other game entities controlled by the player or attributed to him) have been destroyed or incapacitated;
The online computer game player has run out of resources to continue participating in the battle (energy, food, fuel or other, depending on the game mechanics);
The time allotted for the battle has expired;
All opponents have ceased to participate in the battle;
The online computer game player wishes to complete the battle.

### Exemplary Areas of Application

In one or more embodiments, the described embodiments of win-win battles can be applied in various game genres, including, without limitation:
Strategies;
Multiplayer online role-playing games;
Shooters;
Royal battles;
Fighting games; and
Military simulators,

and any others.

In one or more embodiments, the described embodiments of win-win battles can be implemented for both multiplayer and single-player modes (games).

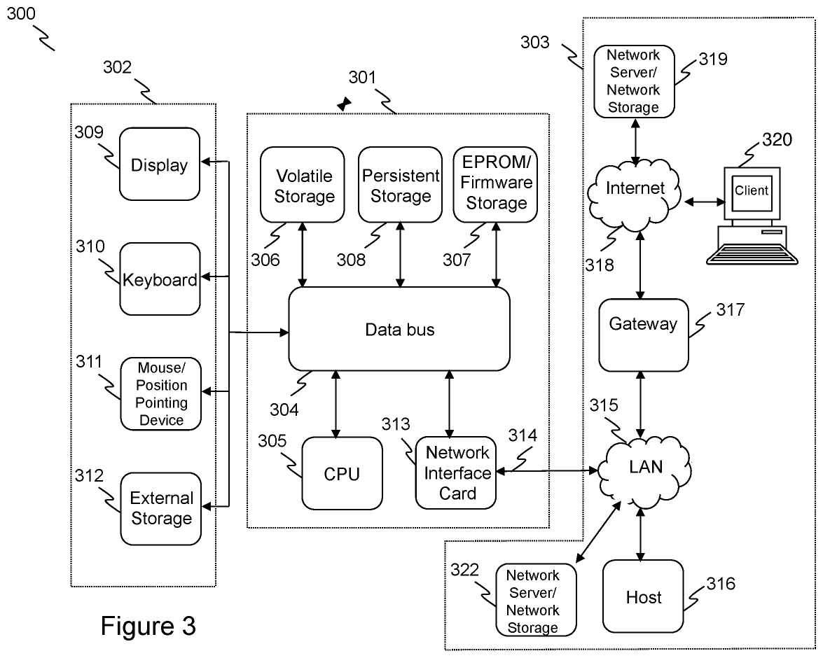

FIG. 3 is a block diagram that illustrates an embodiment of a computer system 300 upon which various embodiments of the inventive concepts described herein may be implemented. The system 300 includes a computer platform 301, peripheral devices 302 and network resources 303.

The computer platform 301 may include a data bus 304 or other communication mechanism for communicating information across and among various parts of the computer platform 301, and a processor 305 coupled with bus 304 for processing information and performing other computational and control tasks. Computer platform 301 also includes a volatile storage 306, such as a random access memory (RAM) or other dynamic storage device, coupled to bus 304 for storing various information as well as instructions to be executed by processor 305, including the software application for proxy detection described above. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 304 for storing information and instructions.

Computer platform 301 may be coupled via bus 304 to a touch-sensitive display 309, such as a cathode ray tube (CRT), plasma display, or a liquid crystal display (LCD), including display of various mobile devices, for displaying information to a system administrator or user of the computer platform 301. An input device 310, including alphanumeric and other keys, is coupled to bus 304 for communicating information and command selections to processor 305. Another type of user input device is cursor control device 311, such as a mouse, a trackball, a controller of a gaming device, a controller virtual reality helmets or goggles, a BCI controller (brain-computer interfaces), or cursor direction keys for communicating direction information and command selections to processor 305 and for controlling cursor movement on touch-sensitive display 309. This input device typically has two degrees of freedom in two axes, a first axis (e.g., x) and a second axis (e.g., y), that allows the device to specify positions in a plane. To detect user's gestures, the display 309 may incorporate a touchscreen interface configured to detect user's tactile events and send information on the detected events to the processor 305 via the bus 304.

An external storage device 312 may be coupled to the computer platform 301 via bus 304 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 308. Volatile media includes dynamic memory, such as volatile storage 306.

Common forms of computer-readable media include, for example, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) or a cellular network interface supporting 3G, 4G or 5G protocols, to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 314 typically provides data communication through one or more networks to other network resources. For example, network link 314 may provide a connection through local network 315 to a host computer 316, or a network storage/server 322. Additionally or alternatively, the network link 314 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client 320 through the Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for implementing multiplayer online computer games. It is intended that the specification and examples be considered as exemplary only, with a true scope and spirit of the invention being indicated by the following claims.

What is claimed is:

1. A computer-implemented method performed in a computerized system comprising a central processing unit, a network interface and a memory, the computer-implemented method for implementing win-win game battles in an online multiplayer computer game, wherein the online multiplayer computer game players are rewarded for the game battle based on their personal or team contributions and not based solely on the fact of winning the game battle.

2. The computer-implemented method of claim 1, wherein the online multiplayer computer game player's contribution is determined based on player's actions such as damage, healing, curing, building, assisting to other players or in game characters or other actions of the player according to the particular gameplay implementation.

3. The computer-implemented method of claim 1, wherein the online multiplayer computer game player's contribution is determined based on an amount of damage done, damage experienced, damage healed during the gameplay.

4. The computer-implemented method of claim 1, wherein the online multiplayer computer game player's contribution is determined based on a combination of metrics, based on a specific implementation of the online multiplayer computer game mechanics.

5. The computer-implemented method of claim 1, wherein all online multiplayer computer game players are considered victorious in the game battle, and those online multiplayer computer game players who done more specified actions receive a higher reward.

6. A non-transitory computer-readable medium embodying a set of computer-executable instructions, which, when executed in a computerized system comprising a central processing unit, a network interface and a memory, cause the computerized system to perform a method for implementing win-win game battles in an online multiplayer computer game, wherein the online multiplayer computer game players are rewarded for the game battle based on their contributions and not based solely on the fact of winning the game battle.

7. The non-transitory computer-readable medium of claim 6, wherein the online multiplayer computer game player's contribution is determined based on specific actions performed in the game.

8. The non-transitory computer-readable medium of claim 6, wherein the online multiplayer computer game player's contribution is determined based on an amount of damage done, damage experienced, damage healed during the battle.

9. non-transitory computer-readable medium of claim 6, wherein the online multiplayer computer game player's contribution is determined based on a combination of metrics, based on a specific implementation of the online multiplayer computer game mechanics.

10. The non-transitory computer-readable medium of claim 6, wherein all online multiplayer computer game players are considered victorious in the game battle, and those online multiplayer computer game players who done more specified actions receive a higher reward.

11. A computerized system comprising a central processing unit, a network interface and a memory storing a set of instructions executable by the central processing unit, the set of instructions comprising instructions for performing a method for implementing win-win game battles in an online multiplayer computer game, wherein the online multiplayer computer game players are rewarded for the game battle based on their contributions and not based solely on the fact of winning the game battle.

12. The computerized system of claim 11, wherein the online multiplayer computer game player's contribution is determined based on damage inflicted on game opponents.

13. The computerized system of claim 11, wherein the online multiplayer computer game player's contribution is determined based on an amount of damage done, damage experienced, damage healed during the battle.

14. The computerized system of claim 11, wherein the online multiplayer computer game player's contribution is determined based on a combination of metrics, based on a specific implementation of the online multiplayer computer game mechanics.

15. The computerized system of claim 11, wherein all online multiplayer computer game players are considered victorious in the game battle, and those online multiplayer computer game players who fight longer and who have done more damage to game opponents receive a higher reward.
